(19) United States
(12) Patent Application Publication
(10) Pub. No.: US 2017/0020787 A1
(43) Pub. Date: Jan. 26, 2017

(54) Infant Bottle with Formula Timer

(71) Applicants: Turkijane Guri, Neenah, WI (US); Shpend Shehu, Neenah, WI (US)

(72) Inventors: Turkijane Guri, Neenah, WI (US); Shpend Shehu, Neenah, WI (US)

(21) Appl. No.: 15/216,681

(22) Filed: Jul. 21, 2016

Related U.S. Application Data
(60) Provisional application No. 62/195,330, filed on Jul. 22, 2015.

(51) Int. Cl. A61J 9/00; G04G 11/00; A61J 11/00

(52) U.S. Cl. CPC A61J 9/00; A61J 11/004; G04G 11/00

(57) ABSTRACT

A infant bottle provides a timer to alert the user when an hour has elapsed. The infant bottle provides an endcap with a ring of LED lights around the base of the bottle, and a recessed button in the center of the bottom surface. Pressing the button once activates a one-hour timer. When the hour expires, the LED lights flash on and off until the button is pressed twice. Pressing the button twice at any time deactivates the timer. The endcap is easily removed for the purpose of placing the bottle in a dishwasher for cleaning.

### CROSS-REFERENCE TO RELATED APPLICATIONS

This Application claims the benefit of U.S. Provisional Application No. 62/195330, filed Jul. 22, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to infant and child care accessories and in particular to an infant bottle with a formula timer. Certain types of infant formula, once they are mixed and poured into an infant bottle, are limited to one hour of safe consumption. At the end of the hour, any formula which has not been consumed by the infant must be taken away and discarded. Unfortunately, many busy parents find it difficult to keep track of the time and carrying around a timer is not practical for parents.

A search of the prior art reveals various timers which have been developed to alert users regarding the freshness of the contents of a container. None are closely related to the present invention, but several include features which resemble those of the present invention. Each has proven to be less than satisfactory in its own way. The present invention has been developed for the purpose of addressing and resolving these disadvantages.

Baby bottle timer, U.S. Pat. No. 7,061,832 (filed Dec. 3, 2004), provides a baby bottle timer which includes a timer configured to have a maximum two-hour time period. An adjustable band attached to the timer is configured to removably attach the baby bottle timer to a baby bottle. The timer has a switch mechanism and a display with changeable indicia displaying an initial indicia at the beginning of the time period and a different indicia at the end of the time period.

Safety timer, U.S. Patent App. Pub. No. US2008/0087622 (filed Oct. 16, 2006), provides a safety timer for use with a baby bottle or the like, comprising a timer portion and a band portion, where the band portion is reversibly retained on a baby bottle and holds the timer portion in a position suitable for use. The timer portion provides an indication of the status of the period of use during which the prepared formula is still considered to be safe to offer to the infant. The safety timer of the present invention may also include an identification tag to ensure the association of the baby bottle with a particular infant.

Perishable item expiration timer, U.S. Patent App. Pub. No. US2006/0181961 (filed Feb. 14, 2005), provides a timer for displaying the conclusion of a first period of time after a perishable item has been placed into a container. Appropriate periods of time include 3 days, 7 days, or other time periods of any duration selected to correspond to the useful life of a perishable item. The timer includes a display, a first programming button permanently associated with the first period of time, and a timing processor electrically connected between the display and the first programming button. The timing processor may be configured to count the first period of time upon receipt of an input from the first programming button. The timing processor is further configured to cause the display to indicate the conclusion of the first period of time. The timer may include a housing which is selectively attachable to the container. Alternatively the display, first programming button, and timing processor may be permanently integrated into either the lid or body of the container.

Device to record age of food, U.S. Pat. No. 6,817,192 (filed Apr. 23, 2001) provides a timer device having an LCD digital readout describing the elapsed days and hours per day. The timer device further provides a reset button to reset the timer device, which is removably attached to a ferromagnetic catch having a double sided adhesive tape attached to one face for attaching the catch to a food storage container, and the timer device started. Upon retrieving the timer device and the first magnet portion is returned to the refrigerator or freezer door, and the empty container and the attached catch can be washed in a dishwasher.

Freshness indicator for beverage and food containers, U.S. Patent App. Pub. No. US2008/0279724 (filed May 9, 2007), provides beverage and food containers having a freshness indicator, where the containers include at least one indicator to detect the degree of freshness of the beverage contained therein.

Container having an audible signaling device, U.S. Pat. No. 5,464,092 (filed Jun. 6, 1994) provides an audible signaling device which is mounted on a product container and is actuated by the opening of the container. The signaling device comprises a power source, a memory for storing data corresponding to audible tones, an electronic sound generator for accessing the memory and generating audible tones, and a switch for connecting the electronic sound generator to the power source. The switch is responsive to the opening of the container whereupon audible tones are produced.

Most of these inventions are permanently secured to the container and cannot be removed for the purpose of cleaning the container. Also, most of these inventions do not provide an unobtrusive visual alert which is unlikely to startle or frighten an infant. An infant bottle with a formula timer, which is removable for cleaning purposes and provides a subtle visual alert at the end of one hour, would resolve these problems.

### SUMMARY OF THE INVENTION

Accordingly, the invention is directed to an infant bottle with a formula timer. The infant bottle provides an endcap with a ring of LED lights around attached to the base of the bottle, and a recessed button in the center of the bottom surface. Pressing the button once activates a one-hour timer. When the hour expires, the LED lights flash on and off until the button is pressed twice. The LED lights provide subtle and gentle illumination, such that they will not startle or frighten an infant who is feeding from the bottle. Pressing the button twice at any time deactivates the timer. The endcap is easily removed for the purpose of placing the bottle in a dishwasher for cleaning.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serves to explain the principles of the invention.

FIG. 1 is a side view of the first exemplary embodiment, displaying the bottle 10, the endcap 11, and the LED lights 12.

FIG. 2 is a side perspective transparency view of the first exemplary embodiment, displaying the bottle 10, the endcap 11, the LED lights 12, and the button 13.

FIG. 3 is a side transparency view of the first exemplary embodiment with the endcap removed, displaying the bottle 10, the endcap 11, and the LED lights 12.

FIG. 4 is a bottom view of the first exemplary embodiment, displaying the endcap 11, and the button 13.

FIG. 5 is a side perspective exploded view of the endcap of the first exemplary embodiment, displaying the endcap 11, the lid 14, the battery compartment 15, and the batteries 16.

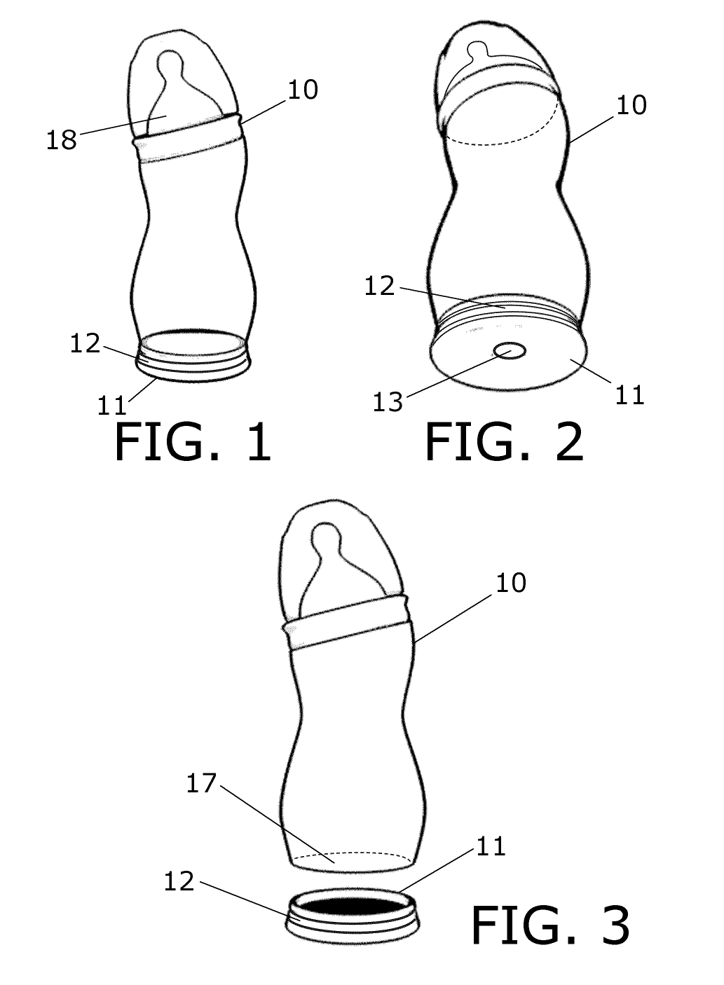

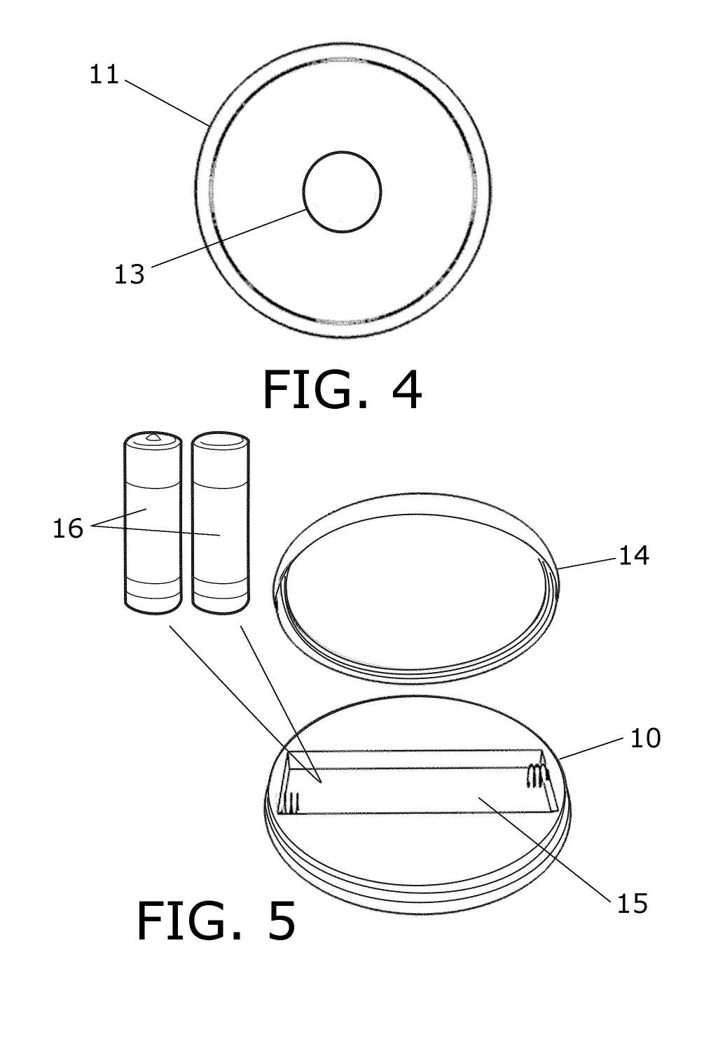

### DETAILED DESCRIPTION OF THE INVENTION

Referring now to the invention in more detail, the invention is directed to an infant bottle 10 with a formula timer. The infant bottle 10 provides an endcap 11 with a ring of LED lights 12 attached to the base 17 of the bottle 10 and a recessed button 13 in the center of the bottom surface. Pressing the button 13 once activates a one-hour timer. When the hour expires on the timer, the timer controls the LED lights 12 to flash on and off until the button 13 is pressed twice. The LED lights 12 provide subtle and gentle illumination, such that they will not startle or frighten an infant who is feeding from the bottle. Pressing the button 13 twice at any time deactivates the timer. The endcap 11 is easily removed for the purpose of placing the bottle 10 in a dishwasher for cleaning.

In other respects, the structure and function of the bottle 10 are conventional for an infant bottle. The bottle 10 is preferably shatterproof and dishwasher safe. The endcap 11 provides a removable lid 14 covering a battery compartment 15 and one or more disposable batteries 16. The timer is a conventional one-hour electric timer, powered by the batteries 16.

To use the first exemplary embodiment, the user may mix infant formula, pour it into the infant bottle 10, and activate the one-hour timer by pressing the button 13. If there is formula remaining at the end of one hour, the timer causes the LED lights 12 to flash, and may be deactivated by pressing the button 13 twice. If the infant consumes the formula before the hour has expired, the user may press the button 13 twice to deactivate the timer.

The bottle 10 and the endcap 11 are preferably manufactured from a rigid, durable material which is dishwasher safe, such as plastic, providing a nipple 18 which is preferably manufactured from a flexible, durable material which is dishwasher safe, such as silicone or plastic. The LED lights 12, the button 13, the lid 14, the battery compartment 15, the batteries 16, and the timer are preferably manufactured from rigid, durable materials such as plastic, steel, aluminum alloy, and copper alloy.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An infant bottle with a formula timer, comprising: an infant bottle having a base, providing a removable endcap attached to the base; the removable endcap providing a ring of LED lights; a timer; and a recessed button on a bottom surface of the endcap; wherein said ring of LED lights are controlled by the timer.

2. The infant bottle of claim 1, wherein the recessed button is configured to activate the timer when pressed once.

3. The infant bottle of claim 1, wherein the timer is configured to last for one hour.

4. The infant bottle of claim 3, wherein the ring LED lights flash on and off when the timer expires.

5. The infant bottle of claim 2, wherein the timer is configured to last for one hour.

6. The infant bottle of claim 3, wherein the ring of LED lights are deactivated when the recessed button is pressed twice.

7. The infant bottle of claim 1, wherein the ring of LED lights provide subtle and gentle illumination.

8. The infant bottle of claim 4, wherein the ring of LED lights provide subtle and gentle illumination.

9. The infant bottle of claim 2, wherein the timer is deactivated by pressing the recessed button twice.

10. The infant bottle of claim 1, wherein the removable endcap is easily removed.

11. The infant bottle of claim 1, wherein the bottle is shatterproof and dishwasher safe.

12. The infant bottle of claim 1, wherein the removable endcap provides a removable lid, the lid covering a battery compartment and one or more batteries.

13. The infant bottle of claim 1, wherein the timer is an electric timer, and powered by batteries.

14. The infant bottle of claim 4, wherein the timer is an electric timer, and powered by batteries.

15. The infant bottle of claim 1, wherein the bottle and the removable endcap are manufactured from a rigid, durable material which is dishwasher safe, such as plastic, providing a nipple which is manufactured from a flexible, durable material which is dishwasher safe, such as silicone or plastic.

16. The infant bottle of claim 1, wherein the LED lights, the recessed button, the lid, the battery compartment, the batteries, and the timer are manufactured from rigid, durable materials such as plastic, steel, aluminum alloy, and copper alloy.
